(19) United States
(12) Patent Application Publication
(10) Pub. No.: US 2022/0165176 A1
(43) Pub. Date: May 26, 2022

(54) METHOD OF DUAL DIRECTION READING

(71) Applicant: Gary Richard, Danvers, MA (US)

(72) Inventor: Gary Richard, Danvers, MA (US)

(21) Appl. No.: 17/101,555

(22) Filed: Nov. 23, 2020

(51) Int. Cl. G09B 17/04; G09B 17/00; G06F 40/103

(52) U.S. Cl. CPC G09B 17/04; G06F 40/103; G09B 17/003

(57) ABSTRACT

A system and method on a computer of more efficient, directional reversing reading format that may have directional guides is shown. The reader's eyes can smoothly and efficiently drop down to the next line, and then read content, as the eyes reverse naturally to the beginning direction. There also may be directional prompts to aid in the smooth flow of reading each line.

### BACKGROUND OF THE INVENTION

### Field of the Invention

The present invention is in the field of reading. More specifically, the present invention is a method of dual direction reading.

### Background of the Invention

The present invention is a more efficient, dual direction reading format, directional reversing reading format or reverse reading, with directional guides. The current problem that needs to be solved is reading in a single direction because this is inefficient, it is more time consuming, and more tiring to the reader's eyes. With conventional text, usually left to right, the reader must do a restart for every line, first by returning the eyes to the left, and then locating the line, and then re-start the reading process for each new line. This is inefficient and it is disruptive to the flow of the reading process and story line, etc. The reader's eyes can smoothly and efficiently drop down to the next line, and then read content, as the eyes reverse naturally to the beginning direction. There are also directional prompts to aid in the smooth flow of reading each line.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a method of dual direction reading, in accordance with one embodiment of the present invention.

FIG. 2 illustrates a method of dual direction reading, in accordance with one embodiment of the present invention.

FIG. 3 illustrates a method of dual direction reading, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

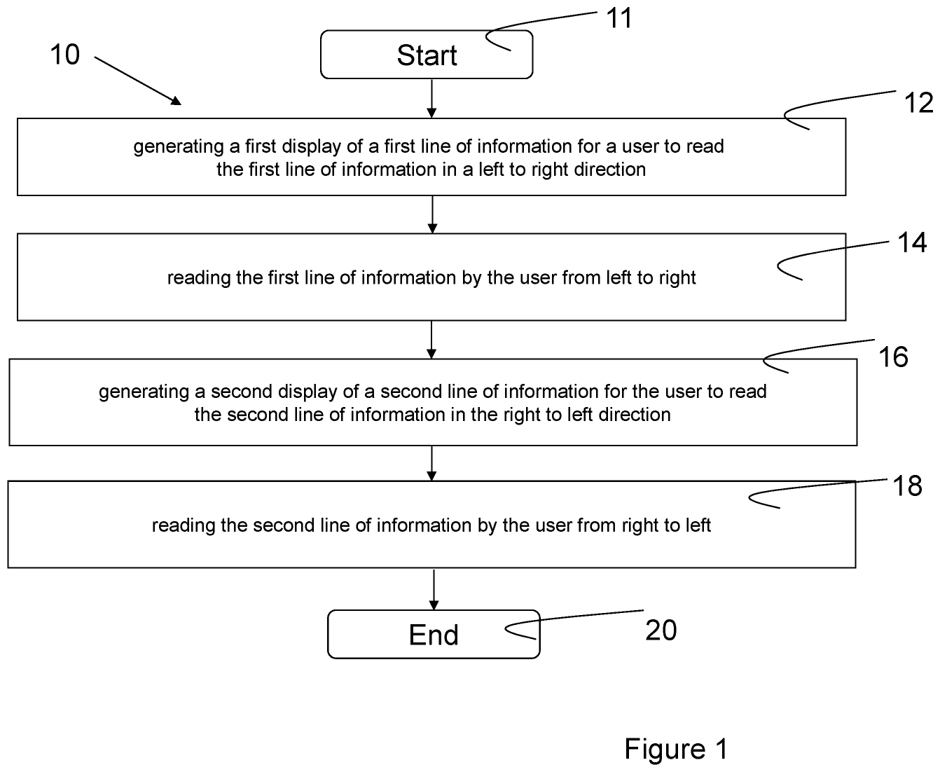

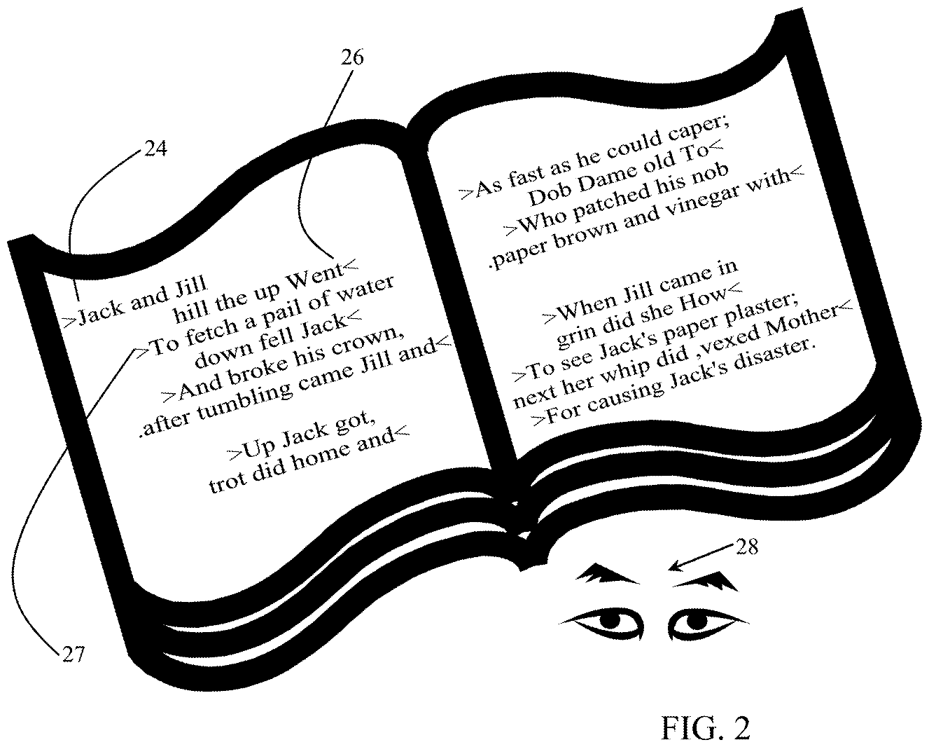

Referring now to FIG. 1, illustrated is a method of dual direction reading 10 in a start 11, in accordance with one embodiment of the present invention. In FIG. 1, illustrated is a method of text flow with dual direction formatting having generating a first display of a first line of information for a user to read then reading the first line of information by the user from left to right 12 then generating a second display of a second line of information for the user to read 14 the second line of information in the right to left direction 16; and reading the second line of information by the user or a reader from right to left 18 and end 20. The reader may be a person. In FIG. 2, illustrated is reading a story about Jack and Jill from left to right 24 and went up the hill from right to left 26 by a user 28. Shown are directional guides or directional indicators 27.

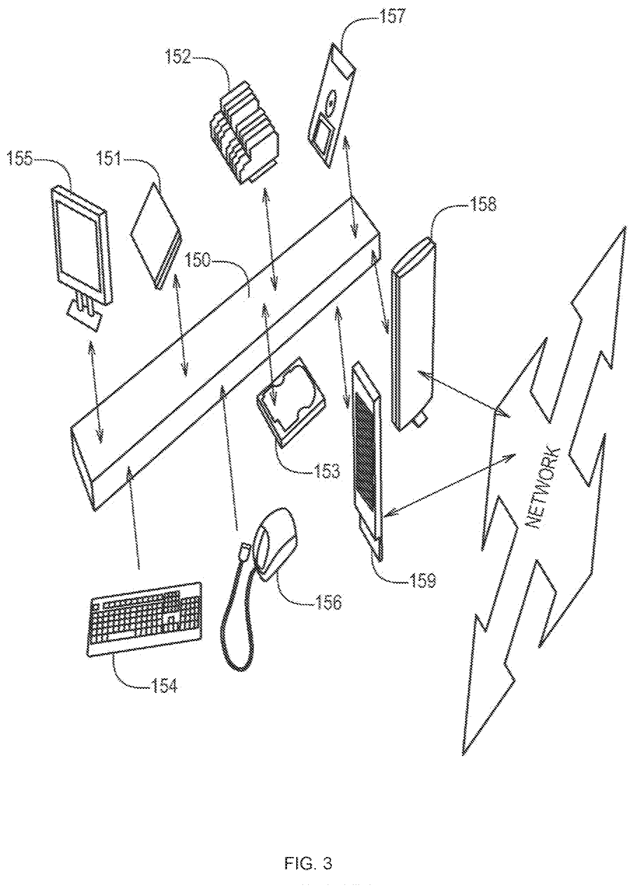

FIG. 3 is an exploded diagonal side perspective diagram of a computer system 150, in accordance with one embodiment of the present invention. Such a computer system 150 includes a processing unit such as a CPU 151 connected by a bus to a random access memory or RAM 152, a storage device 153, a keyboard 154, a display 155 and a mouse 156. In addition, there is software 157 for entry of data embodying the method of dual direction reading 10. An example of a computer system 150 can be a Dell personal computer operating on the Microsoft Windows operating system, or Linux, Macintosh, etc. The invention can also be used on a laptop computer, cell phone, PDA, Apple™ Mac™, tablet, or other computerized device. The computerized system 150 can also be used in combination with a wireless modem 158 or network interface card 159.

As stated above, reading in a single direction, is inefficient, it is more time consuming, and more tiring to the reader's eye's. The invention claimed here solves this problem. Dual direction text, which if starting left to right, as in most languages, the next line of text would be reversed, and read from right to left. There would be directional indicators, such as > and < at the beginning, and ends, of the written text, which indicate the direction to read in. This can also be used in musical compositions, or any other singular direction communication format.

The present invention differs from what currently exists. Once a reader's eyes finish reading a standard line of text, usually left to right, the eyes must travel back to the left, and then drop down, and repeat the process for each line. With dual direction text, the reader only needs to drop their eyes down to the next line, and read in the reverse direction. This saves on eye movement, line locating, time and fatigue.

The present invention is an improvement on what currently exists. Once a reader's eyes finish reading a standard line of text, usually left to right, the eyes must travel back to the left, and then drop down, and repeat the process for each line. With Dual direction text, the reader only needs to drop their eyes down to the next line, and read in the reverse direction. This saves on eye movement, line locating, time and fatigue.

Conventional text is inefficient, time consuming, tiring and disruptive to the flow of the reading process, requiring a virtual re-start for every new line of text. The reader's eyes can smoothly and efficiently drop down to the next line, and then read content, as the eyes reverse naturally to the beginning direction. There are also directional prompts to aid in the smooth flow of reading each line.

Also, it can produce any communication function, which relies on the singular direction format may be improved by the reverse formatting. Every other line of text is written in the opposite direction. There are directional indicators, such as > and < to guide the reader's eyes. The words, in the reverse direction, are spelled in the conventional manor, the lettering of the word and word structure are not reversed, only the sentence structure is reversed.

In another embodiment, the left to right, and right to left text, could also be formatted with different fonts, and/or or different colors, and/or color shades, etc., to indicate text direction.

The directional indicators (Item #2 ><) (please read line one from left to right, per directional indicator >, and then read line two, right to left, per directional indicator <).

>shows the conventional text direction

.(1 Item) direction reverse the and<

In general sentence structures have words written in a singular direction, which requires the reader's eye's to return to the left to start the next reading line. In the present invention the reversed text format, reverses all the text of every other text line to be read in the opposite direction so that the eyes can easily drop down to see the next word and continue reading right to left, and then drop down to the next word and read left to right, and so on.

There are directional indicators, such as > and < to aid the reader to easily follow the text for each line. All odd numbered lines would have a right directional prompt, such as a right facing arrow >, and the text would be written in the left to right formatting, all even numbered lines would be written in the right to left formatting and begin with a left facing prompt, such as a left facing arrow <. Optional features could include different fonts, colors, or color shades to indicate text direction.

The reverse text could be written without the use of directional indicators, though it would be less efficient. Any written text would adopt the reverse text format, with or without the directional indicators, or other options.

Additionally, teleprompters are used for speakers to read to the audience in a way that the audience does not know that the speaker is reading their speech, but the speaker's eyes need to travel back to the left to read the next line, and the audience can sometimes see the eye movement and delay. With the reverse text formatting, the speaker's eyes can naturally, and gradually, look back to the left without any hesitation, delay, or obvious eye movement, or loss of place. Musical scores could also be written in the reverse formatting for more continuous flow of the music reading and hence the improved performances. For a person reading in Braille, the conventional formatting is even more difficult to locate the next line of reading, it would be far more efficient to be able to drop down to the next line and have a continuous flow, as opposed to having to return to the left and restarting the reading process, for each line. The basic Braille code is called grade 1 Braille and is a direct substitution of normal print letters for letters from the Braille alphabet. Grade 2 is a shorter form where certain letter combinations and other frequently used short words are given an abbreviated Braille pattern. These abbreviations make reading and writing Braille much faster, which would be enhanced by the more continuous flow with the dual direction formatting.”

Also, it can create: Any communication function, which relies on the singular direction format may be improved by the reverse formatting. Jack and Jill, with Dual Direction Formatting (DDF).

>Jack and Jill
hill the up Went<
>To fetch a pail of water
down fell Jack<
>And broke his crown,
.after tumbling came Jill and<
>Up Jack got,
trot did home and<
>As fast as he could caper;
Dob Dame old To<
>Who patched his nob
.paper brown and vinegar with<
>When Jill came in
grin did she How<
>To see Jack's paper plaster;
next her whip did, vexed Mother<
>For causing Jack's disaster.

A method of displaying and reading text flow with a dual direction format by implementing the method of displaying and reading text flow with a dual direction format via a computer. Generating by the computer a first display of a first line of information for a user to read from left to right on a computer device display or pages of a book. Reading the first line of information by the user from left to right. Generating by the computer a second display of a second line of information for the user to read from right to left on the computer device display or pages of a book. Reading the second line of information by the user from right to left. The method of displaying and reading text flow with a dual direction may have directional indicators to guide user's eyes from the first line of information to the second line of information. A user reading system having a computer to implement the user reading system. A reverse reading pattern of text provided by the computer the reverse reading pattern of text for the user to read the text on a display of the computer or pages printed by the computer in a book to increase the user's reading speed, efficiency and comprehension. A first line of text for the user to read the first line of text from left to right from the text organized by the computer. A second line of text for the user to read the second line of text from right to left from the text organized by the computer. The first line of text presented by the computer directly above the second line of text and a last word of the first line of text presented by the computer directly above a pre-defined word connected to a first word of the second line of text making a zig zag reading pattern of text from left to right then right to left. Directional indicators may be used to guide user's eyes from the first line of text to the second line of text. A method of dual direction reading by a user with implementing the method of dual direction reading by a user having a text flow via a computer. Determining a dual direction format to the text flow by the computer and generating the text flow in the dual direction format from a user specified predetermined content that allows the user to read with less eye movement the text flow displayed on a computer device screen or pages of a book.

Transforming by the computer the user specified predetermined content into the dual direction format. The user specified predetermined content is the user picking a novel written by an author of the novel. The user specified predetermined content is the user creating live text material by typing into the computer or dictating into the computer. Rearranging by the computer the user specified predetermined content into the dual direction format. Directional indicators may be used to guide user's eyes in the dual direction format.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A method of displaying and reading text flow with a dual direction format comprising:
implementing the method of displaying and reading text flow with a dual direction format via a computer;
generating by the computer a first display of a first line of information for a user to read from left to right on a computer device display or pages of a book;
reading the first line of information by the user from left to right the first line of information shown on the computer device display or pages of a book;
generating by the computer a second display of a second line of information for the user to read from right to left on the computer device display or pages of a book; and
reading the second line of information by the user from right to left the second line of information shown on the computer device display or pages of a book.

2. The method of displaying and reading text flow with a dual direction format of claim 1 wherein directional indicators guide user's eyes from the first line of information to the second line of information.

3. A user reading system comprising:
a computer to implement the user reading system;
a reverse reading pattern of text provided by the computer the reverse reading pattern of text for the user to read the text on a display of the computer or pages printed by the computer in a book to increase the user's reading speed, efficiency and comprehension;
a first line of text for the user to read the first line of text from left to right from the text organized by the computer;
a second line of text for the user to read the second line of text from right to left from the text organized by the computer
the first line of text presented by the computer directly above the second line of text; and
a last word of the first line of text presented by the computer directly above a pre-defined word connected to a first word of the second line of text making a zig zag reading pattern of text from left to right then right to left.

4. The method of claim 3 wherein directional indicators guide user's eyes from the first line of text to the second line of text.

5. A method of dual direction reading by a user comprising:
implementing the method of dual direction reading by a user having a text flow via a computer;
determining a dual direction format to the text flow by the computer; and
generating by the computer the text flow in the dual direction format from a user specified predetermined content that allows the user to read with less eye movement the text flow displayed on a computer device screen or pages of a book.

6. The method of claim 5 wherein transforming by the computer the user specified predetermined content into the dual direction format with the dual direction content being arranged for all text of every other text line to be read by the user in an opposite direction so that the users eyes can easily drop down to see a next word and continue reading right to left and then drop down to the next word and read left to right.

7. The method of claim 5 wherein the user specified predetermined content is the user picking a novel written by an author of the novel

8. The method of claim 5 wherein the user specified predetermined content is the user creating live text material by typing into the computer or dictating into the computer.

9. The method of claim 5 wherein rearranging by the computer the user specified predetermined content into the dual direction format.

10. The method of claim 5 wherein directional indicators guide user's eyes in the dual direction format that include all odd numbered lines would have a right directional prompt that is a right facing arrow > and the text flow would be written in the left to right formatting, all even numbered lines would be written in the right to left formatting and begin with a left facing prompt that is a left facing arrow <.

11. The method of claim 5 wherein directional indicators guide user's eyes in the dual direction format that include all odd numbered lines would have a first font and the text flow would be written in the left to right formatting, all even numbered lines would be written in the right to left formatting and have a second font.

12. The method of claim 5 wherein directional indicators guide user's eyes in the dual direction format that include all odd numbered lines would have a first color and the text flow would be written in the left to right formatting, all even numbered lines would be written in the right to left formatting and have a second color.

13. The method of claim 5 wherein directional indicators guide user's eyes in the dual direction format that include all odd numbered lines would have a first color shade and the text flow would be written in the left to right formatting, all even numbered lines would be written in the right to left formatting and have a second color shade.
